(19) United States
(12) Patent Application Publication
(10) Pub. No.: US 2024/0071664 A1
(43) Pub. Date: Feb. 29, 2024

(54) Joint Schemes for Stacked Plate, Non-Insulated Superconducting Magnets

(71) Applicant: Massachusetts Institute of Technology, Cambridge, MA (US)

(72) Inventors: Vincent FRY, Durham, NC (US); Rui VIEIRA, Billerica, MA (US)

(73) Assignee: Massachusetts Institute of Technology, Cambridge, MA (US)

(21) Appl. No.: 18/259,907

(22) PCT Filed: Jan. 27, 2022
(86) PCT No.: PCT/US2022/014021

§ 371 Date: Jun. 29, 2023

Related U.S. Application Data
(60) Provisional application No. 63/143,189, filed on Jan. 29, 2021.

(51) Int. Cl. H01F 6/06

(52) U.S. Cl. CPC H01F 6/06

(57) ABSTRACT

Schemes are described for joint geometry and placement in superconducting magnets. According to some aspects, a joint may be implemented in a modular component of a superconducting magnet, such as a plate that includes a spiral superconducting path, with the joints providing electrically conductive connections between the superconducting paths of adjacent plates. A joint may be installed and coupled to the component (e.g., plate) after its fabrication, thereby providing freedom in design of both the joint and the component. In at least some cases, the joints may be arranged to be flush with a surface of the component after installation into the component so that neighboring instances of the components may be stacked flush with one another, thereby putting joints from the neighboring components into intimate contact with one another.

### CROSS-REFERENCE TO RELATED APPLICATIONS

The present application claims the benefit under 35 U.S.C. § 119(e) of U.S. Provisional Patent Application No. 63/143,189, filed Jan. 29, 2021, titled “Joint Schemes for Stacked Plate, Non-Insulated Superconducting Magnets,” which is hereby incorporated by reference in its entirety.

### BACKGROUND

Superconductors are materials that have no electrical resistance to current (are “superconducting”) below some critical temperature. For many superconductors, the critical temperature is below 30° K, such that operation of these materials in a superconducting state requires significant cooling, such as may be achieved with liquid helium or supercritical helium.

High-field magnets are often constructed from superconductors due to the capability of superconductors to carry a high current without resistance. Such magnets may, for instance, carry currents greater than 5 kA.

### SUMMARY

According to some aspects, a magnet is provided comprising a plurality of plates arranged in a stack that includes a first plate and a second plate, the first plate comprising a first conducting path, at least part of the first conducting path being a spiral path, the first conducting path comprising a high temperature superconductor (HTS) material, and a first conductive joint arranged interior to, or exterior to, the spiral path of the first conducting path, the first conductive joint being electrically coupled to the HTS material of the first conducting path, and the second plate being arranged next to the first plate in the stack and comprising a second conducting path comprising the HTS material, and a second conductive joint arranged adjacent to and electrically coupled to the first conductive joint, the second conductive joint being electrically coupled to the HTS material of the second conducting path.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, identical or nearly identical components illustrated in various figures may be represented by a like numeral. For purposes of clarity, not every component may be labeled in every drawing.

FIG. 1A is a cross-section of a portion of an illustrative plate suitable for use in a stacked-plate superconducting magnet, according to some embodiments;

FIG. 1B is a cross-section of a portion of an illustrative plate suitable for use in a stacked-plate superconducting magnet with an alternate joint design, according to some embodiments;

FIG. 1C is a cross-section of a portion of an illustrative plate suitable for use in a stacked-plate superconducting magnet with a second alternate joint design, according to some embodiments;

FIG. 2 is a cross-section of two illustrative plates in a stacked-plate superconducting magnet, according to some embodiments;

FIG. 3A is a cross-section of neighboring joints in a superconducting magnet, according to some embodiments;

FIG. 3B depicts the magnet shown in FIG. 3A with a superconductor provided within the conducting channels of the joints, according to some embodiments;

FIG. 4 is a cross-section of neighboring joints in a superconducting magnet, according to some embodiments;

FIGS. 5A and 5B depict top perspective views of a baseplate for a stacked-plate superconducting magnet, according to some embodiments;

FIG. 6 is a cross-section of a superconducting magnet comprising a plurality of plates comprising joints at inner and outer sides, according to some embodiments;

FIG. 7 is a cross-section of a superconducting magnet comprising a plurality of plates mirrored around a central plane, according to some embodiments; and

FIG. 8 is a three-dimensional graphic of a fusion power plant with a cutaway portion illustrating various components of the power plant, according to some embodiments

### DETAILED DESCRIPTION

A high-field superconducting magnet often comprises multiple electrically insulated turns of a superconductor grouped in a multi-layer arrangement. When the superconductor is cooled below its critical temperature (the temperature below which the electrical resistivity of the material drops to zero), current may pass through the superconducting path without losses that would normally occur due to electrical resistance.

A superconducting magnet and/or systems to which it is coupled may include current paths made from a non-superconducting conductor (also referred to as a “normal conductor”). For instance, an interface between the superconductor in the magnet and a power supply may comprise a normal conductor. In other cases, there may be connections between regions of superconductor within the magnet to facilitate construction of the magnet. An interconnection to and/or within a superconducting magnet is sometimes referred to as a “joint.” The joint may comprise a normal conductor as in the example above, but in other cases may be an interconnection between neighboring regions of superconductor.

In general, it is desirable that joints in a superconducting magnet have a number of properties. First, the electrical resistivity of the joints should be as low as possible, since current flowing through the joints will cause joule heating of the joints and a superconducting magnet is operated at low temperatures. Second, the joint should be mechanically robust. During operation, a superconducting magnet can produce large forces within its structure (e.g., Lorentz forces), which can result in the application of forces (e.g., compressive forces) onto the joints as well as onto other portions of the structure. For this reason, joints in a superconducting magnet may be thought of as being ‘electromechanical’ structures rather than mere electrical conductors. Third, it is preferable that joints in a superconducting magnet are easy to manufacture. Fourth, it is preferable that the joints take up a relatively small amount of space (and ideally minimal space) in the superconducting magnet so that more space is available for inclusion of a superconductor within the magnet.

Conventional superconducting magnet joints generally rely on special preparation of the superconductor so that superconducting coils can be joined together. As noted above, it is desirable that joints have a low electrical resistance, so directly connecting different regions of superconductor is one way to meet this goal. Such approaches can, however, be extremely complex and error-prone to fabricate. For instance, neighboring regions of superconductor must be measured and cut so that they can be in intimate contact with one another when joined, while having identical contact resistance to ensure uniform current distribution within the joint. These approaches may also produce fixed assemblies once constructed—that is, once the neighboring regions of superconductor have been mounted onto one another, it may be difficult or impossible to demount the joint without damaging or destroying it.

The inventors have recognized and appreciated joint designs that utilize normal conductors (i.e., non-superconductors). The joint design may be implemented in a modular component of a superconducting magnet, such as a plate that includes a spiral superconducting path, with the joints described herein providing electrically conductive connections between the superconducting paths of adjacent modular components (e.g., between adjacent plates in a stack of plates). A joint may be installed and coupled to the component (e.g., plate) after its fabrication, thereby providing freedom in design of both the joint and the component. In at least some cases, the joints may be arranged to be flush with a surface of the component after installation into the component so that neighboring instances of the components may be stacked flush with one another, thereby putting joints from the neighboring components into intimate contact with one another. Moreover, this design may allow the components to be fabricated to comprise the joints prior to the components being coupled to one another, thereby allowing a flexible, modular and convenient fabrication process.

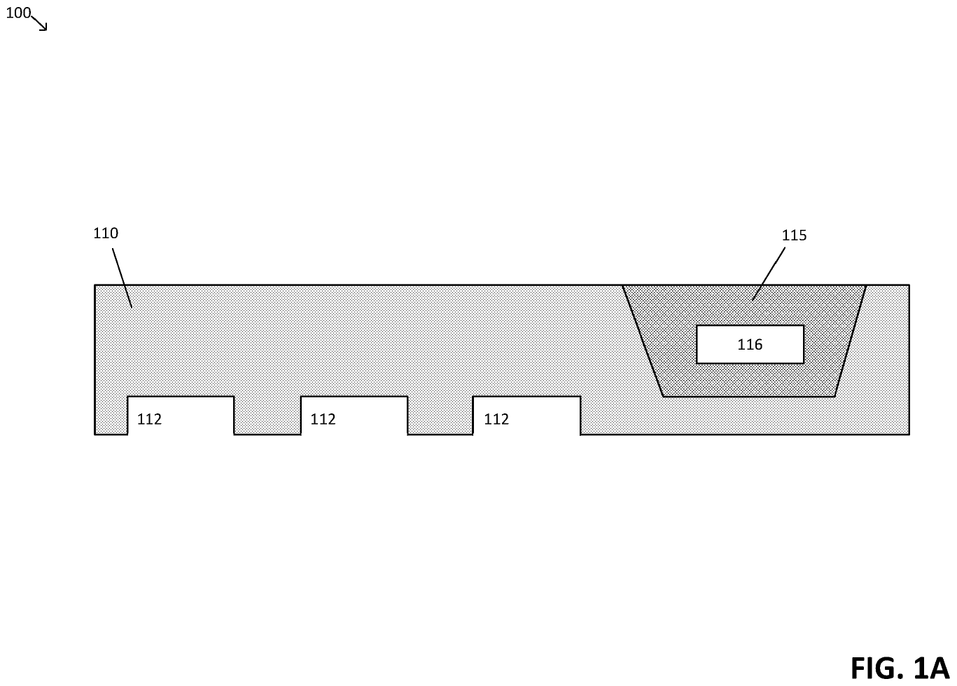

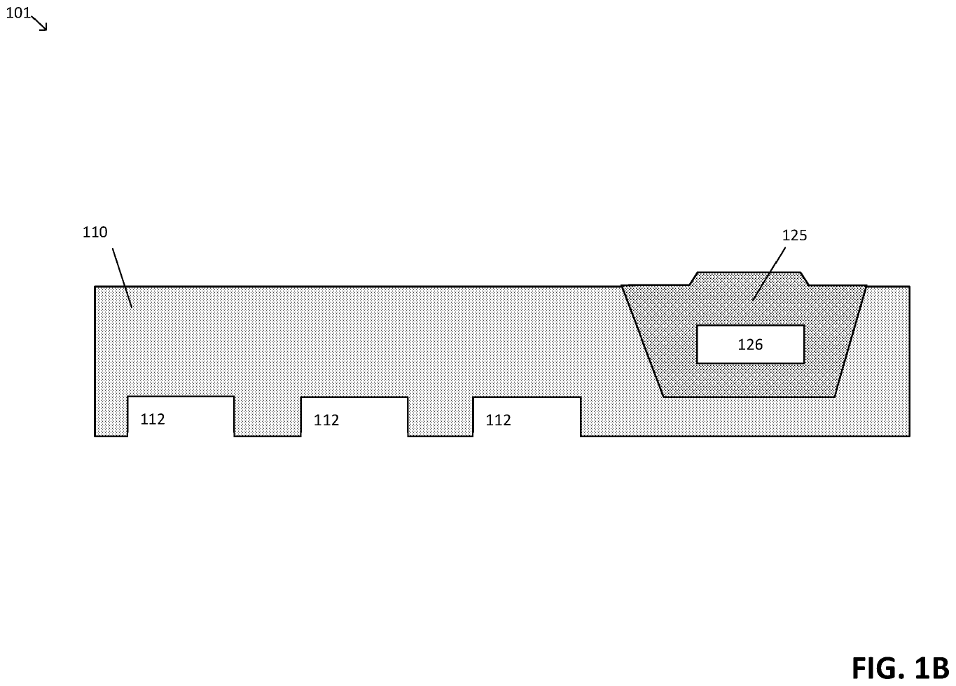

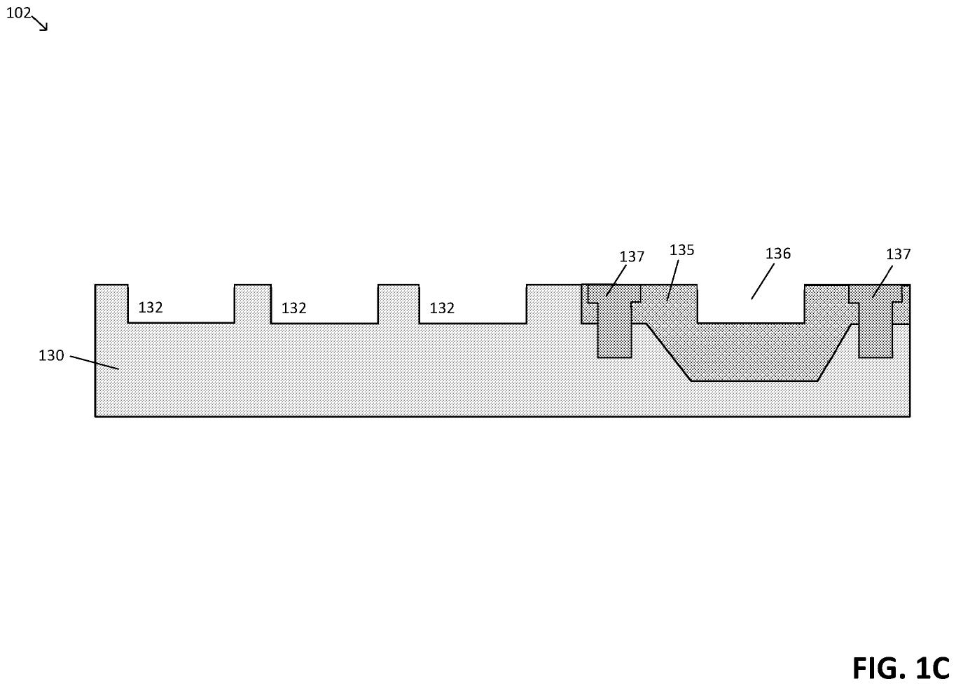

FIG. 1A is a cross-section of a portion of an illustrative plate suitable for use in a stacked-plate superconducting magnet, according to some embodiments. In the example of FIG. 1, plate 100 comprises a baseplate material 110 in which a conducting path 112 is formed (e.g., via traditional machining processes, via additive and/or subtractive processes, etc.). To produce a magnet, a superconductor may be inserted into the conducting path of the baseplate 110. The conducting path 112 may comprise channels, grooves and/or any other space into or onto which a superconductor may be provided.

In the example of FIG. 1A, the conducting path may be a curved path with successive turns of the path lying within the previous turns, such as but not limited to a spiral path or a plurality of concentric circular paths. An outer part of the conducting path is coupled to a joint 115, which comprises or consists of a normal conductor such as copper. The joint 115 comprises a conducting path 116, which is an interior space (e.g., a channel) within the joint into which the superconductor that is to be inserted into the conducting path 112 may also be inserted. As such, when the joint 115 is installed, disposed, or otherwise provided in the baseplate 110, the conducting path 112 and conducting path 116 may be arranged adjacent to one another to form a continuous path. The superconductor may thereby be arranged within the path formed by the combination of conducting paths 112 and 116.

According to some embodiments, adjacent instances of the plate 100 (or instances of a similar plate, examples of which are described below) may be arranged so that joints 115 of the plates electrically couple to one another. As a result, a superconductor within the conducting path 112 may be arranged in a plurality of turns within one plate, with one end of the superconductor electrically coupled to (e.g., terminating with) the joint 115, which couples to a joint of another plate, which is coupled to another superconductor in that plate, etc. In this manner, a stack of plates 100 may be arranged with a plurality of regions of a superconductor to form a continuous current path through the stack, with the joints providing the current path across neighboring plates. In some embodiments, this current path may comprise an alternating sequence of inward and outward spirals, with each plate being configured with the conducting path being either an inward spiral path or an outward spiral path. In this case, the joint 115 may be arranged at an interior of the spiral or at an exterior of the spiral. In some embodiments, the plate 100 may include a joint 115 at an exterior of the conducting path 112 and a second joint at an interior of the conducting path, with the two joints being arranged to be exposed on opposing faces of the plate, thereby facilitating connections to neighboring plates at the exterior of the conducting path on one side of the plate and at the interior of the conducting path on the other side of the plate.

According to some embodiments, the baseplate 110 may comprise, or may consist of, a high mechanical strength material such as but not limited to steel, Inconel®, Nitronic® 40, Nitronic® 50, Incoloy®, or combinations thereof. In some embodiments, the baseplate 110 may be plated with a metal such as nickel to facilitate adhesion of other components to the plate, including solder as described below.

In the example of FIG. 1A, the conducting path 112 is shown as being at a first surface of the baseplate 110 (here illustrated as an exterior bottom surface of the baseplate 110), though it will be appreciated that the current path may be arranged at any suitable location within the plate, including within the interior of the plate, and/or on the exterior top surface of the plate 110.

According to some embodiments, the joint 115 may comprise, or may consist of, copper. In some embodiments, the joint may be mechanically coupled to the baseplate 110 via bolts or other fasteners. In some embodiments, the bolts may provide some amount of electrical coupling between the baseplate and the joint. Additionally, or alternatively, the joint may be coupled to the baseplate 110 via other means, such as by attaching the joint to the baseplate with a solder, brazing or welding the joint to the plate. A solder arranged between the joint and the baseplate and mechanically coupling the two together may also provide electrical coupling between the two. As such, electrical continuity between the plates may be increased by the addition of electrically conducting material around the joints, for example by soldering the perimeter of the joints.

The geometry of the joint 115 may, according to some embodiments, allow the joint 115 to be inserted into the baseplate 110 subsequent to the plate being fabricated. In this case, it may be advantageous to mechanically couple (i.e., removably couple) the joint to the plate rather than fixedly couple (e.g., via brazing or welding) the joint to the plate. In some embodiments, subsequent to installation of the joint 115 in the baseplate 110, a molten solder may be introduced into the plate to fill any gaps between the joint and the plate. In some cases, the molder solder process may also be introduced into the conducting path 112 to fill any gaps between the baseplate 110 and a superconductor introduced into the path.

According to some embodiments, prior to its installation in the plate 110, some or all of the joint 115 (e.g., the interior of conducting channel 116 and/or the exterior of the joint that will contact the baseplate 110) may be pre-tinned with a metal (e.g., a PbSn solder, plated with silver, etc.) to promote a good bond (e.g. a mechanical and/or electrical connection) between the joint and a subsequently-deposited solder. The joint may be inserted into (or otherwise provided in) the plate and optionally secured to the plate (e.g., fastened to the plate via one or more mechanical fasteners such as via bolts). A conductive material may then be deposited into the groove in which the joint was inserted (or otherwise provided) via a vacuum pressure impregnation (VPI) process. Such a process may comprise one or more of the following steps: cleaning the empty space within the plate using an acidic solution following by a water rinse; evacuating space from within the plate; purging the space with an inert gas; depositing flux into the space to coat the joint 115; draining any excess flux from the plate; heating at least part of the plate to a temperature below, at, or above a temperature at which the alloy to be deposited will melt; and flowing a molten alloy (e.g., a PbSn solder) into the plate.

According to some embodiments, baseplate 110 may comprise one or more through holes (i.e., one or more holes extending from a first surface of the plate to a second, opposite surface of the plate—not shown in FIG. 1A) for attaching the plate to other plates and/or other structures. In some cases, the through holes may comprise an interior thread to facilitate insertion of threaded mechanical fasteners such as screws or bolts into or through the plate.

According to some embodiments, baseplate 110 may comprise one or more cooling channels for delivering coolant to a superconductor arranged within the conducting channel 112. The cooling channels may be arranged adjacent to the conducting channel 112 and/or may be arranged anywhere else within the plate 100. In some cases, the joint 115 may have a geometry such that an empty region remains between the joint and the baseplate 110 after the joint is inserted into the baseplate. Such an empty region may be used as a cooling channel. The joint design described herein may thereby allow for flexibility in coolant channel design within the plates.

According to some embodiments, joint 115 may be machined to have a smooth upper surface—that is, the exposed surface that will contact another joint within another plate. A smooth surface may decrease contact resistance (i.e., may decrease electrical resistance between two mechanical structures in contact with each other). In this instance a smooth surface may decrease contact resistance between the joint 115 and the joint within the other plate, thereby leading to less Joule heating of the joints and/or nearby materials.

The example of FIG. 1A depicts a plate that may be suitable for use in a non-insulated (NI) magnet design (also referred to as a no-insulation (NI) magnet), in which adjacent superconducting turns of the magnet are not insulated from one another but are instead separated by a normal conductor (i.e., not a superconductor). In this instance, the normal conductor is the baseplate 110. When the magnet is operating below the superconductor's critical temperature, current flows through the superconductor and not across turns because the superconductor has zero resistance compared with the finite resistance of the conductor that lies between the turns.

During a quench, however, at least one or more portions of the superconductor may be in a “normal” (non-superconducting) state (i.e., at least one or more portions of the superconductor have a finite resistance rather than a zero resistance which is characteristic of a superconductor). The at least one or more portions of the superconductor having a normal resistance are sometimes referred to as “normal zones” of the superconductor. When normal zones appear, at least some zero resistance current pathways are no longer present, causing the current to flow through the normal zones and/or between the turns, with the balance of current flow between these pathways depending on their relative resistances. By diverting at least some current from the superconducting material when it is normal in this manner, therefore, NI magnets, and in particular non-insulated high temperature superconductor (NI-HTS) magnets (NI magnets that comprise HTS), can in principle be passively protected against quench damage without the need to continuously monitor quench events and/or to actively engage external quench protection mechanisms.

FIG. 1B is a cross-section of a portion of an illustrative plate suitable for use in a stacked-plate superconducting magnet with an alternate joint design, according to some embodiments. FIG. 1B illustrates a plate 101 comprising the same baseplate 110 as in the example of FIG. 1A (and which also includes the same conducting path 112), but with a joint 125 which has a different geometry to the joint 115 shown in FIG. 1A. But for the different geometry on the upper surface of the joint 125, all of the above comments with respect to FIG. 1A also apply to FIG. 1B, with the conducting path 126 being a path within the joint 125 that may be arranged adjacent to the conducting path 112 just as for the conducting path 116 in the example of FIG. 1A.

According to some embodiments, the upper surface of the joint 125 may not be arranged flush with the upper surface of the baseplate 110 but may include a notch or other feature designed to mate with a complementary feature in the joint of a neighboring plate. In the example of FIG. 1B, for instance, the joint 125 includes a section that protrudes above the upper surface of the baseplate 110, with the remainder of the joint being flush with the upper surface of the baseplate. Another plate may be fabricated that includes a joint with a section that is recessed below the upper surface of the baseplate 110, with the remainder of the joint being flush with the upper surface of the baseplate. As a result, these joints may mate together when the plates are arranged adjacent to one another. The approach of FIG. 1B may increase or simplify alignment of adjacent plates and/or may provide for a more robust electrical connection between the two joints by increasing the contact area between the two plates, compared with the example of FIG. 1A. In some embodiments, the height of the protrusion of the joint 125 may be less than 0.02 inches (e.g., 0.015 inches) above the face of the joint 125. It should be appreciated that the protruding portion may be provided having any regular or irregular geometric shape. The shape of the protruding portion may be selected to suit the needs of a particular application.

FIG. 1C is a cross-section of a portion of an illustrative plate suitable for use in a stacked-plate superconducting magnet with a second alternate joint design, according to some embodiments. FIG. 1C illustrates a plate 102 comprising a baseplate 130 in which conducting path 132 is formed. The baseplate also includes a channel into which joint 135 is inserted. Joint 135 includes a conductive channel 136 and is mechanically coupled to the baseplate 110 via bolts 137. The joint 135 thereby includes through holes for the bolts and the baseplate 130 includes holes aligned with the through holes in the joint for insertion of the bolts.

The above comments with respect to FIG. 1A may also apply to the example of FIG. 1C with respect to joint 135, baseplate 130, conducting path 132 and conducting path 136; and joint 105, baseplate 110, conducting path 112 and conducting path 116, respectively. In the example of FIG. 1C it may be noted, however, that the conducting paths 132 and 136 are arranged at the uppermost surface of the baseplate 130 and joint 135, respectively. This positioning of the paths within the baseplate and the joint may simplify the insertion of superconductor into the paths compared with the examples of FIGS. 1A-1B, since in FIG. 1C the paths are exposed at the top of the plate after installation of the joint into the baseplate.

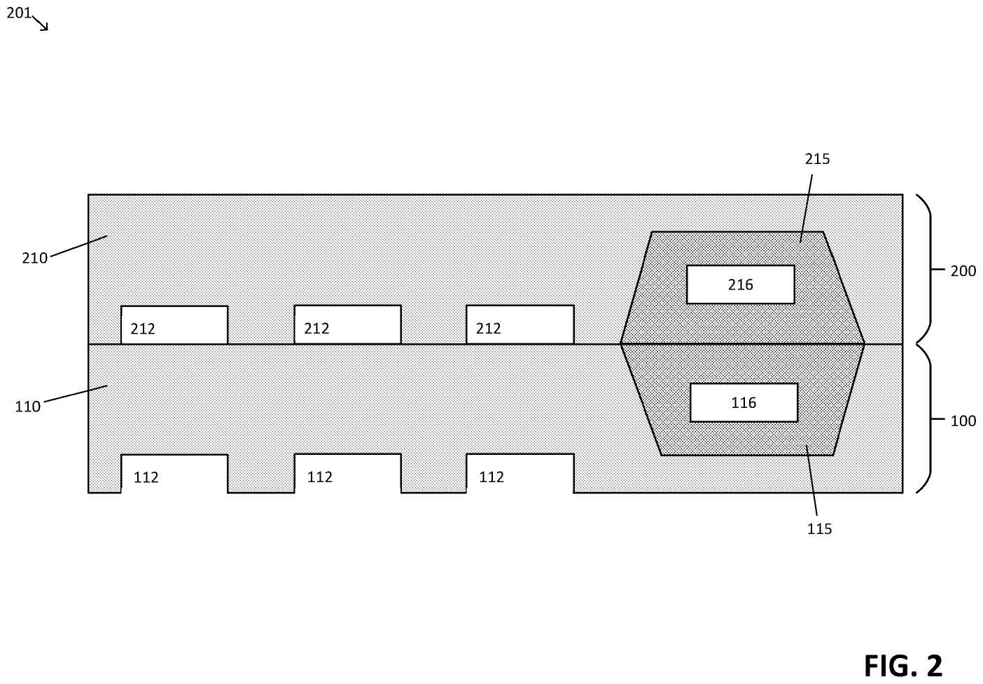

FIG. 2 is a cross-section of two illustrative plates in a stacked-plate superconducting magnet, according to some embodiments. The example of FIG. 2 depicts a magnet 201 comprising plate 100 shown in FIG. 1A in contact with a second plate 200, which includes conducting path 212 within baseplate 210, and joint 215 which comprises conducting path 216. As with conducting paths 116 and 112 in the example of plate 100, the conducting path 216 in joint 215 may be arranged to be adjacent to the conducting path 212.

According to some embodiments, a first superconductor may be arranged within conducting paths 112 and 116, and a second superconductor arranged within conducting paths 212 and 216. As a result, during operation at temperatures where the superconductor is superconducting, a current path of the magnet 201 may flow along the first superconductor, through the joint 115 to the joint 215, then along the second superconductor. The joints 115 and 215 may be arranged at an interior end or exterior end of the plates within the magnet and, as discussed above, additional joints may be arranged at the opposing end of the plates irrespective of whether the depicted joints in FIG. 2 are arranged at the exterior or interior end of the plates.

According to some embodiments, a metal layer may be arranged between the joints 115 and 215 to facilitate intimate electrical contact between the joints. The metal may for instance be a soft metal configured to be compressed and conform to the surfaces of the joints during assembly of the magnet. In some embodiments, the metal layer may comprise, or may consist of, indium.

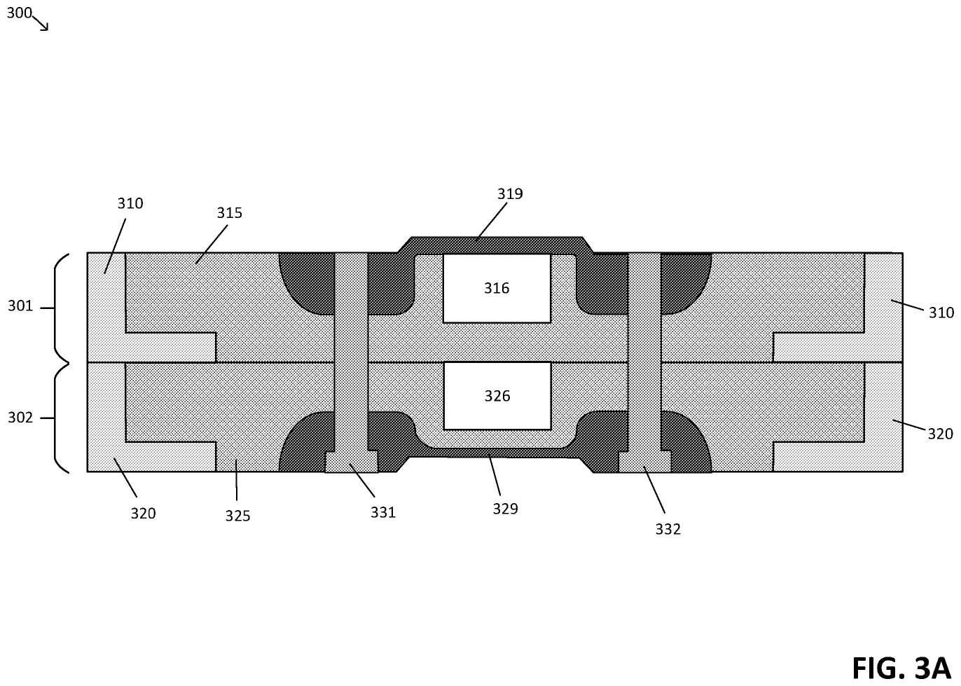

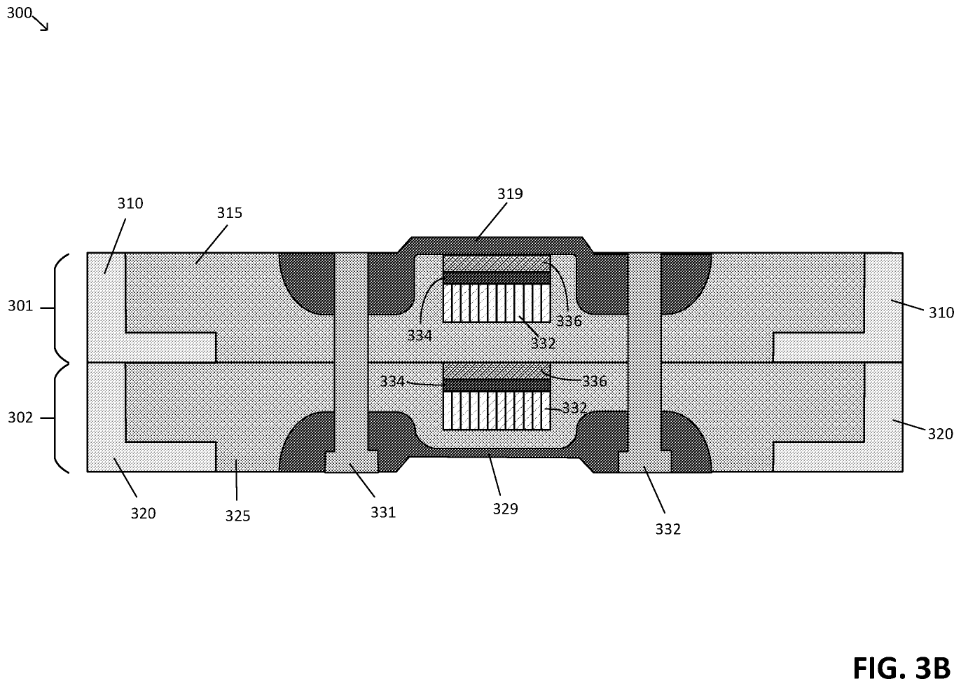

FIG. 3A is a cross-section of neighboring joints in a stacked plate superconducting magnet, according to some embodiments. The example of FIG. 3A depicts an alternate design for the base plate and joint and includes clamps that fasten multiple plates together. Magnet 300 includes plate 301 and plate 302. The plate 301 includes a baseplate 310 of which two portions are shown in the cross-section of FIG. 3A, and the plate 302 includes a baseplate 320 of which two portions are shown in the cross-section of FIG. 3A. Plate 301 includes a joint 315 in which a conducting channel 316 is arranged. Plate 302 includes a joint 325 in which a conducting channel 326 is arranged. The plates 301 and 302 also include clamps 319 and 329, respectively, wherein bolts 331 and 332 pass through the clamps to attach the plates 301 and 302 to one another. As noted above, bolts may be fully or partially threaded to mate with threads provided in one or both of plates 301,302 or threaded to mate with a nut.

According to some embodiments, each plate of magnet 300 may be assembled by inserting the joint into the baseplate, and optionally mechanically attaching the joint to the baseplate (e.g., as in the example of FIG. 1C described above). Superconductor may subsequently be inserted into the conducting path of the baseplate (these paths are not shown in the example of FIG. 3A), and into the conducting path of each joint (e.g., path 316 or 326). Optionally, solder may subsequently be deposited into the conducting paths of the baseplate and joint, such as with a VPI process as described above. A stack of plates formed through this method may then be arranged and the plates coupled to one another through the clamps arranged between adjacent pairs of plates (or between more than two plates). Optionally, a layer of a soft metal such as indium may be arranged between the joints of neighboring plates in the stack so that when force is applied across the joint-joint interfaces by the clamps, the metal conforms to the interface and provides a good electrical contact between the joints.

For purposes of illustration, FIG. 3B depicts the stacked plates shown in FIG. 3A with a superconductor provided within the conducting channels of the joints 315 and 325 (visible in FIG. 3A). In particular, in the conducting paths are arranged an HTS material 332, a cap 336 and an intervening conductive material 334 which provides electrical and thermal contact between the HTS material 332 and cap 336.

In the example of FIG. 3B, the HTS material is provided as a co-wound stack of HTS tape. According to some embodiments, the HTS 332 may comprise a rare earth barium copper oxide superconductor (REBCO), such as yttrium barium copper oxide (YBCO). In embodiments, the HTS tape may comprise a long, thin strand of HTS material. In embodiments, the strand of HTS material may be provided having cross-sectional dimensions in the range of about 0.001 mm to about 0.1 mm in thickness (or height) and a width in the range of about 1 mm to about 12 mm (and with a length that extends into and out of the page in the example of FIG. 3B). According to some embodiments, each strand of HTS tape may comprise an HTS material such as REBCO in addition to an electrically conductive material (referred to as a co-wind). In some embodiments, the electrically conductive material may be disposed on the REBCO. In some embodiments, the electrically conductive material may be a cladding material such as copper. In some embodiments, HTS tape may comprise a polycrystalline HTS and/or may have a high level of grain alignment.

According to some embodiments, cap 336 may comprise, or may consist of, copper. According to some embodiments, conductive material 334 may comprise a Pb and/or Sn solder. In some embodiments, conductive material 334 may comprise a metal having a melting point of less than 200° C., wherein at least 50 wt % of the metal is Pb and/or Sn, and at least 0.1 wt % of the metal is Cu. In some embodiments, the conductive material 334 may be a solder introduced into the plates via a VPI process as discussed above.

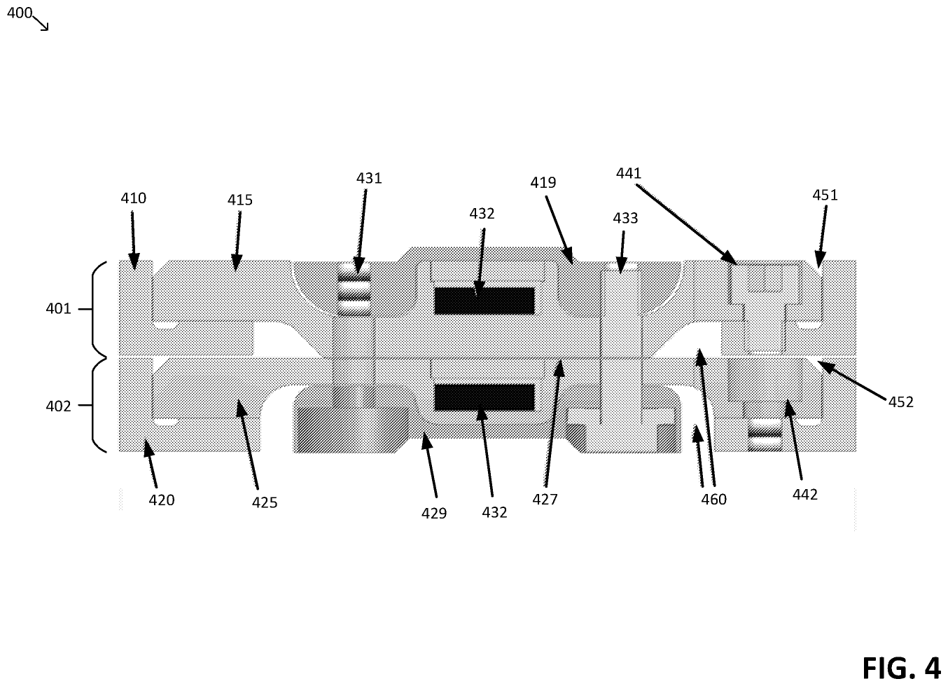

FIG. 4 is a cross-section of neighboring joints in a superconducting magnet, according to some embodiments. FIG. 4 depicts an alternate design to that shown in FIGS. 3A and 3B that includes cooling channels, joint mounting bolts and a chamfer and drain to aid in a VPI process that introduces solder into the plates.

Magnet 400 includes plate 401 and plate 402. The plate 401 includes a baseplate 410 of which two portions are shown in the cross-section of FIG. 4A, and the plate 402 includes a baseplate 420 of which two portions are shown in the cross-section of FIG. 4A. Plates 401 and 402 include joints 415 and 425 respectively, in which a superconductor 432 is arranged within channels therein. The plates 401 and 402 also include clamps 419 and 429, respectively, wherein bolts 431 and 433 pass through the clamps to attach the plates 401 and 402 to one another. A layer 427 of a soft metal such an indium is arranged between the joints. A soft metal layer between the joints may produce a high degree of contact between the joints (e.g., may fill in any imperfections in the surface of either or both joints to ensure the surfaces are flush), and may also allow for the joints to be disassembled and reassembled easily. In some embodiments, the thickness (e.g., vertical direction in FIG. 4) of the combination of joint 425 and clamp 429 may be equal to, or approximately equal to, the thickness of baseplate 420.

In the example of FIG. 4, the joints 415 and 425 are configured so that cooling channels 460 are provided between the joints and their respective base plates (and in the case of plate 402, additionally between the joint and the clamp 429). As shown, the geometries of the baseplates and joints may be selected so as to leave a suitable channel for a coolant between those elements.

In the example of FIG. 4, joint mounting bolts 441 and 442 are included which mount joint 415 to baseplate 410 and joint 425 to baseplate 420, respectively. In the example of FIG. 4, the joints 415 and 425 may have portions shaped to form or otherwise provide drain regions 451 and 452 respectively. In this example, joints 415, 425 have a chamfer shape potion which define (or form) drain region 451, 452. Joints 415 and 425 may, of course, also be provided having other shapes (i.e., portions having shapes other than a chamfer shape) which may define drain regions 451, 452. In some embodiments, the drain region 451 may be arranged to catch excess solder and/or flux that may flow over the surface of a plate during a solder deposition process (e.g., the VPI process described above).

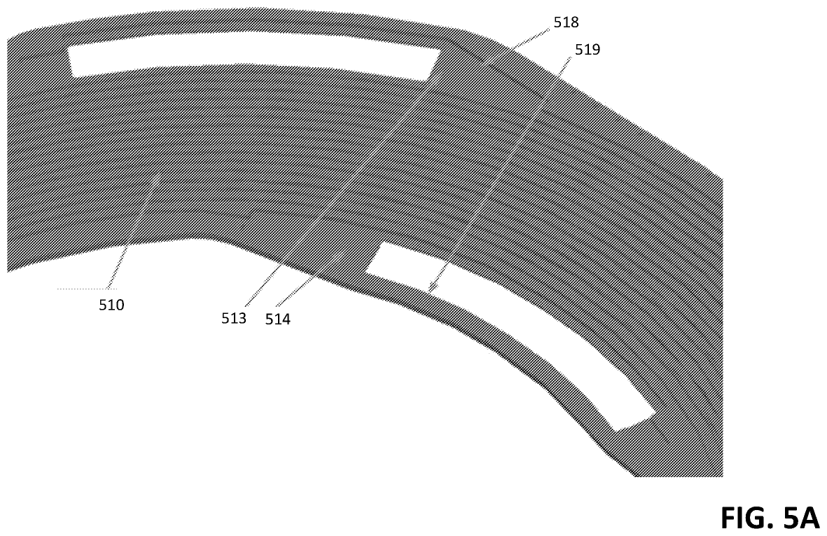

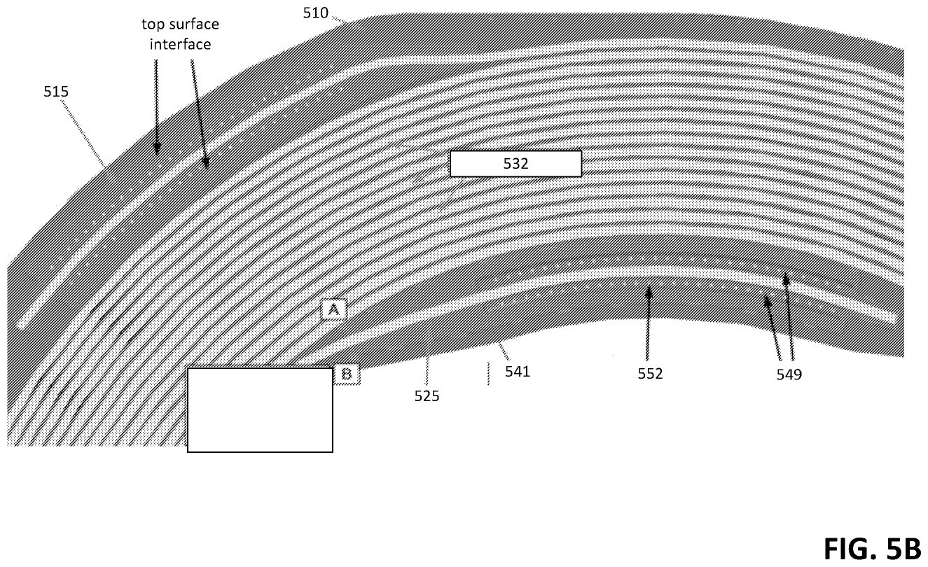

FIGS. 5A and 5B depict top perspective views of a baseplate for a stacked-plate superconducting magnet, according to some embodiments. In the example of FIG. 5A, the baseplate only is shown, whereas in FIG. 5B the same baseplate with joints and a superconductor arranged within the baseplate is shown.

As shown in FIG. 5A, baseplate 510 includes grooves or pockets 513 and 514 into which joints may be inserted. The baseplate also includes mounting locations 518 and 519 for securing the joints to the baseplate (e.g., the mounting locations may comprise threaded or non-threaded holes for bolts).

FIG. 5B depicts the baseplate 510 subsequent to inserting joints 515 and 525 into the baseplate, in addition to superconductor 532. In the example of FIG. 5B, the joint 515 is arranged to have an exposed upper conductive surface (e.g., as in the portion of the plate 402 shown in FIG. 4), whereas the joint 525 is arranged to have an exposed lower conductive surface (e.g., as in the portion of the plate 401 shown in FIG. 4). The joint 525, as shown in FIG. 5B, includes bolts 541 that secure the joint to the baseplate 510, holes 552 for a joint clamp to affix the plate to another plate in the magnet, and grooves or pockets 549 for clamps to be inserted to affix the plate to another plate.

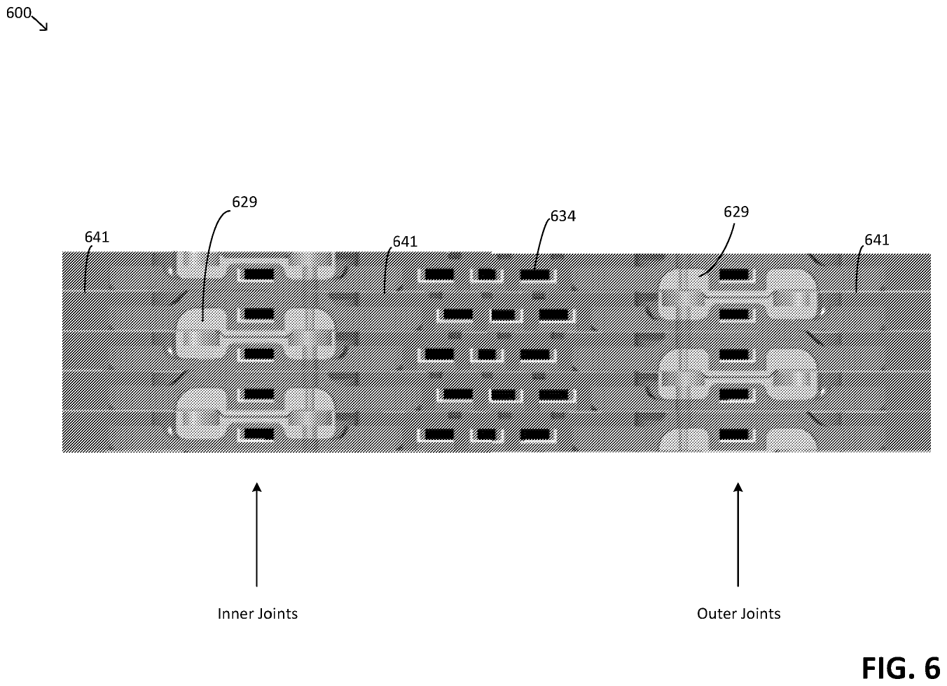

FIG. 6 is a cross-section of a superconducting magnet comprising a plurality of plates each comprising joints at inner and outer sides, according to some embodiments. To further illustrate how the joint design described above may be implemented in a superconducting magnet, FIG. 6 depicts magnet 600 comprising a number of plates that each include an inner joint and an outer joint. In FIG. 6, the uppermost and lowermost plates are cropped but it will be appreciated that the illustrated arrangement could be repeated for as many plates as desired or necessary. In magnet 600, each plate includes four turns of a superconductor 634, and each pair of adjacent plates are clamped together with clamps 629 at either the inner end or the outer end, with the position of the clamps alternating with each successive pair of plates as shown. A layer of insulating material 641 is arranged between adjacent plates except for the region where the joints contact one another (although it will be appreciated that such a layer of insulating material may not be a required feature, as the example of FIG. 3B for instance does not include such a layer). As shown in FIG. 6, this insulating layer may be provided between adjacent clamps in each pair of clamps.

Since, in the example of FIG. 6, the joint design recesses the clamps into the joint, the thickness of the joint plus the clamp is the same (or approximately the same) as the average thickness of a plate itself. As a result, all of the inner joints may be arranged over one another and all of the outer joints may be arranged over one another as shown in FIG. 6. Consequently, the magnet 600 may be formed from only two unique plates (e.g., a so-called A plate and a B plate) where adjacent instances of these plates meet at an inner joint and at an outer joint. This arrangement can be repeated because the plates can nest together since, as noted above, the thickness of the joint plus clamp may be the same (or approximately the same) as the average thickness of a plate. Thus, the joint design techniques described herein enable one to make a magnet comprising a relatively small number of unique plates (in this example only two unique plates are required). The joint design described herein also enables one to make a magnet comprising relatively few total joint locations and thus a small (and ideally minimal) overall volume of the magnet is devoted to joint volume. Thus, the joint design described herein results in a magnet which is relatively simple to assemble (since there are relatively few unique plates) and has a relatively small volume taken up by the joints connecting the magnet plates.

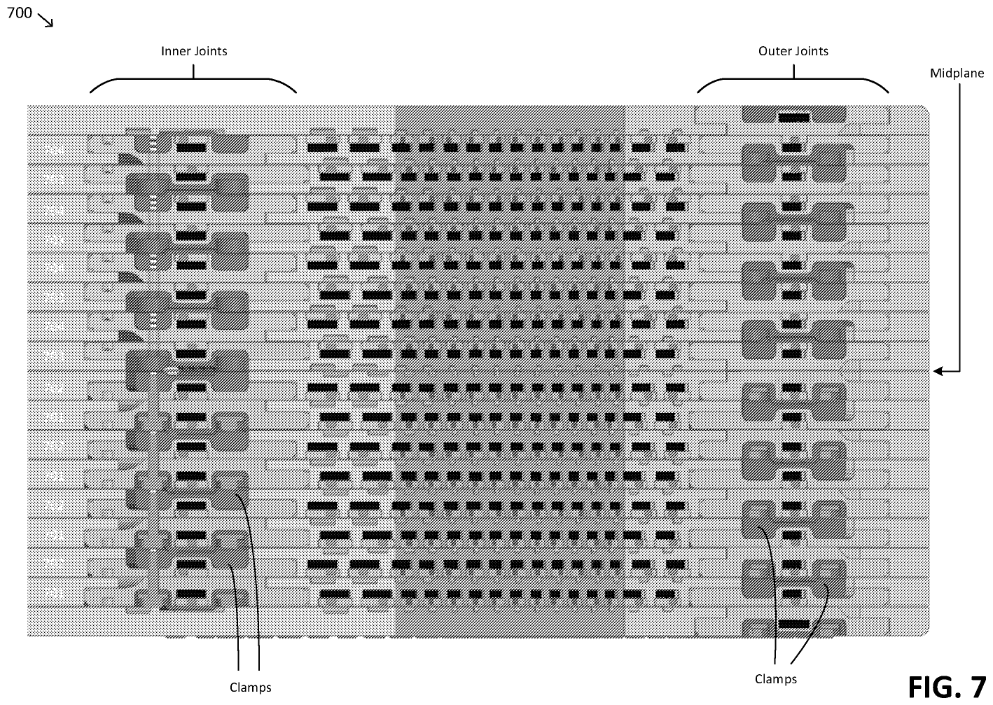

FIG. 7 is a cross-section of a superconducting magnet comprising a plurality of plates mirrored around a central plane, according to some embodiments. In some cases, plates comprising joints as described above may be arranged in a stack that is mirrored around a midplane. Such a stack may include four types of plates, with two types of plates being arranged in an alternating fashion on either side of the midplane.

As shown in the example of FIG. 7, a stack of plates 700 (also referred to as “winding pack”) comprises a plurality of plates mechanically and electrically coupled to one another via the joint coupling techniques described above. As shown, each plate within stack 700 is coupled to adjacent plates via an inner joint and an outer joint. As shown in FIG. 7, the stack 700 includes repeated alternating instances of plates 701 and 702 beneath the midplane, and repeated alternating instances of plates 703 and 704 above the midplane. In some embodiments, the plates 701 and 702 may be mirror images of plates 703 and 704, respectively.

As with the example of FIG. 6, in FIG. 7 the joint design recesses the clamps into the joint, the thickness of the joint plus the clamp is the same (or approximately the same) as the average thickness of a plate itself. As a result, all of the inner joints may be arranged over one another and all of the outer joints may be arranged over one another. Also, as with FIG. 6, the techniques illustrated in FIG. 7 allow one to make a winding pack comprising a relatively small number of unique plates (in this example only four unique plates are required). The joint design described herein also enables one to make a winding pack comprising relatively few total joint locations and thus a small (and ideally minimal) overall volume of the winding pack is devoted to joint volume. Thus, the joint design described herein results in a winding pack which is relatively simple to assemble (since there are relatively few unique plates) and has a relatively small volume taken up by the joints connecting the winding pack plates.

In the example of FIG. 7, a malleable conductive metal (e.g., indium) may be disposed between the plates to provide good electrical connections between the plates in the winding pack. In this particular example, it is preferable that the malleable metal (e.g., the indium) be highly compressed. Suitable compression may be achieved via the joints described herein (e.g., via bolts to pull together clamps (e.g., steel clamps) around the indium).

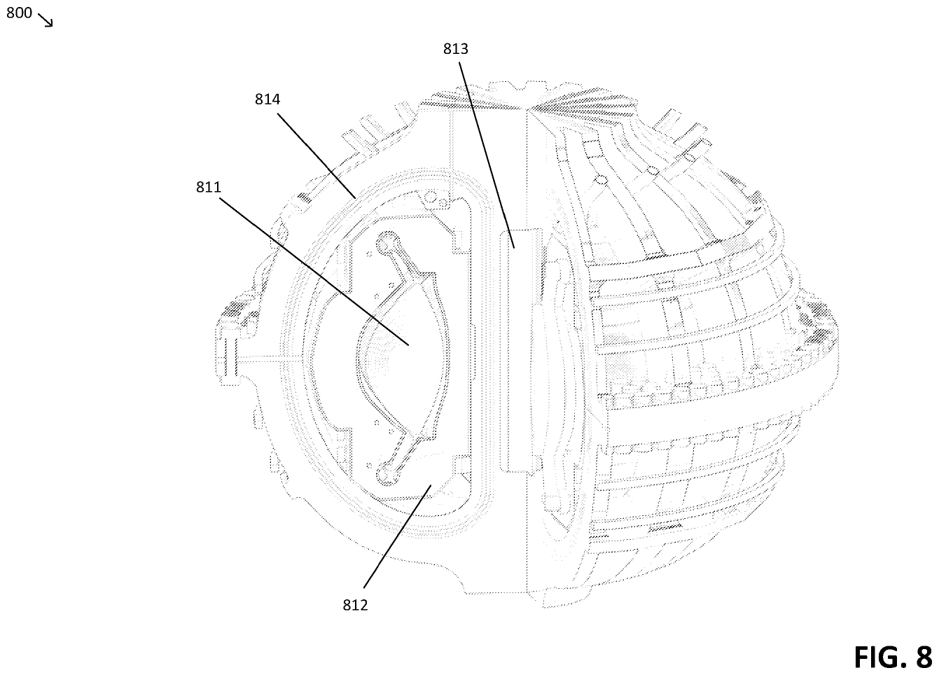

FIG. 8 is a three-dimensional graphic of a fusion power plant with a cutaway portion illustrating various components of the power plant, according to some embodiments. A magnet within a fusion power plant may be formed from a superconductor arrangement as described above. FIG. 8 shows a cross-section through a power plant and includes a magnet coil 814, which is fabricated from, or otherwise includes, a superconducting magnet comprising a stack of plates as discussed and described above, a neutron shield 812, and a core region 811. According to some embodiments, the magnet coil 814 may be, or may form part of, a toroidal field coil. Magnet coil 813 may be fabricated from, or otherwise includes, a superconducting magnet comprising a stack of plates as discussed and described above. According to some embodiments, the magnet coil 813 may be, or may form part of a central solenoid and/or other poloidal field solenoidal coils.

Persons having ordinary skill in the art may appreciate other embodiments of the concepts, results, and techniques disclosed herein. It is appreciated that superconducting coils configured according to the concepts and techniques described herein may be useful for a wide variety of applications, including any application in which superconducting material is wound into a coil to form a magnet. For instance, one such application is conducting nuclear magnetic resonance (NMR) research into, for example, solid state physics, physiology, or proteins, for which superconducting coils may be wound into a magnet. Another application is performing clinical magnetic resonance imaging (MRI) for medical scanning of an organism or a portion thereof, for which compact, high-field magnets are needed. Yet another application is high-field MRI, for which large bore solenoids are required. Still another application is for performing magnetic research in physics, chemistry, and materials science. Further applications are in magnets for particle accelerators for materials processing or interrogation; electrical power generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, processes, and techniques disclosed herein may be put without deviating from their scope.

As used herein, a “high temperature superconductor” or “HTS” refers to a material that has a critical temperature above 30 K, wherein the critical temperature refers to the temperature below which the electrical resistivity of the material drops to zero.

Illustrative examples of conducting paths channels are described herein and illustrated in the drawings. It will be appreciated that the particular size and shape of these channels are provided merely as examples and that no particular cross-sectional shape or size is implied as being necessary or desirable unless otherwise noted.

Having thus described several aspects of at least one embodiment which illustrate the described concepts, it is to be appreciated that various alterations, modifications, and improvements will readily occur to those skilled in the art.

Such alterations, modifications, and improvements are intended to be part of this disclosure and are intended to be within the spirit and scope of the concepts described herein. Further, though advantages of the concepts described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the concepts described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

For purposes of the description herein, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary layers or structures at the interface of the two elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A magnet comprising:
a plurality of plates arranged in a stack that includes a first plate and a second plate, the first plate comprising:
a first conducting path, at least part of the first conducting path being a spiral path, the first conducting path comprising a high temperature superconductor (HTS) material; and
a first conductive joint arranged interior to, or exterior to, the spiral path of the first conducting path, the first conductive joint being electrically coupled to the HTS material of the first conducting path, and
the second plate being arranged next to the first plate in the stack and comprising:
a second conducting path comprising the HTS material; and
a second conductive joint arranged adjacent to and electrically coupled to the first conductive joint, the second conductive joint being electrically coupled to the HTS material of the second conducting path.

2. The magnet of claim 1, further comprising a layer of conductive metal between the first and second conductive joints that contacts both the first conductive joint and second conductive joint.

3. The magnet of claim 2, wherein the layer of conductive metal is a layer of indium.

4. The magnet of claim 1, further comprising at least one bolt coupling the first conductive joint to the first plate.

5. The magnet of claim 1, further comprising at least one bolt coupling the first plate to the second plate, wherein the at least one bolt coupling the first plate to the second plate passes through the first conductive joint and the second conductive joint.

6. The magnet of claim 5, further comprising a first clamp arranged within the first plate and a second clamp arranged within the second plate, and wherein the at least one bolt coupling the first plate to the second plate is also coupled to the first clamp and the second clamp.

7. The magnet of claim 6, wherein the first clamp and the second clamp contact one another.

8. The magnet of claim 6, further comprising an electrically insulating layer between the first and second clamps, and wherein the first clamp and the second clamp contact opposing sides of the electrically insulating layer.

9. The magnet of claim 1, wherein the HTS material of the first conducting path does not contact the second conductive joint, and the HTS material of the second conducting path does not contact the first conductive joint.

10. The magnet of claim 1, wherein at least part of the second conducting path is a spiral path.

11. The magnet of claim 1, wherein the first conducting path further comprises a first conductive material in contact with the HTS material.

12. The magnet of claim 1, further comprising at least one cooling path arranged within the first plate adjacent to the first conductive joint.

13. The magnet of claim 1, wherein the first conductive joint comprises copper.

14. The magnet of claim 1, comprising a plurality of instances of the first plate and a plurality of instances of the second plate arranged in the stack, wherein the plurality of the plates in the stack alternate between the instances of the first plate and the instances of the second plate.

15. The magnet of claim 1, wherein the first plate is formed from a first material in which the first conducting path is formed, and wherein the first material comprises steel.

16. The magnet of claim 1, wherein the spiral path of the first conducting path is a racetrack spiral.

17. The magnet of claim 1, wherein the HTS material comprises a stack of HTS tapes.

18. The magnet of claim 17, wherein each HTS tape of the stack of HTS tapes comprises a rare earth barium copper oxide (REBCO) material wrapped in copper cladding.

19. The magnet of claim 1, wherein the conducting path of the first plate further comprises a Pb and/or Sn solder in contact with the HTS material.
